(19) United States
(12) Patent Application Publication
(10) Pub. No.: US 2025/0149029 A1
(43) Pub. Date: May 8, 2025

(54) ARTIFICIAL INTELLIGENCE ASSISTANCE FOR AN AUDIO, VIDEO AND CONTROL SYSTEM USING ROOM ENVIRONMENT CONTEXTUALIZATION AND ORAL COMMAND INFERENCING

(71) Applicant: QSC, LLC, Costa Mesa, CA (US)

(72) Inventors: Derek Wearin Lieb, Boulder, CO (US); Christopher Jaynes, Costa Mesa, CA (US); Matthew Skogmo, Placentia, CA (US); Thomas Bauer, Forst (DE)

(21) Appl. No.: 18/927,569

(22) Filed: Oct. 25, 2024

Related U.S. Application Data
(63) Continuation-in-part of application No. 18/585,587, filed on Feb. 23, 2024.
(60) Provisional application No. 63/596,646, filed on Nov. 7, 2023.

(51) Int. Cl. G10L 15/183; G06V 20/40; G10L 15/06; G10L 15/22; G10L 15/30

(52) U.S. Cl. CPC G10L 15/183; G10L 15/063; G10L 15/22; G10L 15/30; G06V 20/40; G10L 2015/223; G10L 2015/228

(57) ABSTRACT

An audio, video and control (“AVC”) operating system is implemented on an AVC processing core coupled to one or more peripheral devices. Using a large learning model (“LLM”) module, the AVC system detects audio signals obtained from a user and infers oral commands from the audio signals. Thereafter, one or more actions corresponding to the oral commands are performed on the peripheral devices and/or the AVC processing core. In another embodiment, the AVC system obtains contextual awareness data of a room environment in which the AVC operating system functions. Thereafter, based upon the contextual awareness data, the system performs actions on the peripheral devices or AVC processing core.

### PRIORITY

This U.S. application is a Continuation-in-Part of and claims benefit to U.S. patent application Ser. No. 18/585,587, filed on Feb. 23, 2024, which claims benefit of U.S. Provisional Patent Application No. 63/596,646, filed on Nov. 7, 2023, both of which are hereby incorporated by reference in their entirety.

### FIELD OF THE INVENTION

The present invention relates generally, but not limited to, audio, video and control (“AVC”) systems and, more specifically, to methods and systems using artificial intelligence to control an AVC system, including a processing core and peripherals.

### BRIEF DESCRIPTION OF THE DRAWINGS

FIG. 1 is a block diagram illustrating an overview of an AVC processing core, according to certain illustrative embodiments of the present disclosure.

FIG. 2 is a block diagram of an AVC operating system using a preconfigured command set, according to certain illustrative embodiments of the present disclosure.

FIG. 3 is a flow chart of a generalized method to perform one or more actions on peripheral devices according to illustrative embodiments of the present disclosure.

FIG. 4 is a block diagram of an AVC operating system using user “taught” command sets, according to certain illustrative embodiments of the present disclosure.

FIG. 5 is a flow chart of a computer-implemented method for performing actions on peripheral devices, according to certain illustrative embodiments of the present disclosure.

FIG. 6 is a flow chart of a method of inferring oral commands using audio signals from generalized conversations, according to certain illustrative embodiments of the present disclosure.

FIG. 7 is a flow chart of a method to perform actions on peripheral device(s) using contextual awareness data, according to certain illustrative embodiments of the present disclosure.

### DESCRIPTION OF ILLUSTRATIVE EMBODIMENTS

Illustrative embodiments and related methods of the present disclosure are described below as they might be employed to perform actions on peripheral devices networked on AVC systems using artificial intelligence. In the interest of clarity, not all features of an actual implementation or methodology are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

More specifically, illustrative embodiments of the present disclosure allow users to issue oral commands to perform actions across AVC systems. The oral commands may be implemented using, for example, a large language model (“LLM”). An LLM is an artificial intelligence, deep learning algorithm which performs a variety of natural language processing tasks. As described herein, an AVC system includes a core processor and peripheral equipment such as, for example, speakers, microphones, cameras, bridging devices, network switch, and so on. The operating system being executed by the AVC system performs all of audio, video, and control processing on one processing core. Having all of audio, video, and control processing on one device makes configuring an AVC system much easier because any initial configuration or later changes to a configuration are made at the single processing core. Thus, any audio, video, or control configuration changes (e.g., changing gain levels of an audio device) are made at the single device (core processor), rather than having to make an audio configuration change at one processing device and a video or control configuration change at another processing device. Also, any software or firmware upgrades across the AVC system may be made to the single processing core. Therefore, through use of the presently disclosed embodiments, a user can control the AVC system with oral commands, including any one of the peripherals. In certain embodiments, however, the presently disclosed embodiments are not limited to having all of the audio, video, or control processing performed on one processing core. In certain embodiments, the audio, video, or control processing may occur on any number of processing cores, and in any combination.

In yet other embodiments, the LLM is equipped with a default set of oral commands for the LLM to detect/identify. In other embodiments, the LLM is trained to detect oral commands by way of receiving user input over a web browser or orally.

An AVC system is a system configured to manage and control functionality of audio features, video features, and control features. For example, an AVC system of the present disclosure can be configured for use with networked microphones, cameras, amplifiers, controllers, and so on. The AVC system can also include a plurality of related features, such as acoustic echo cancellation, multi-media player and streamer functionality, user control interfaces, scheduling, third-party control, voice-over-IP (“VoIP”) and Session Initiated Protocol (“SIP”) functionality, scripting platform functionality, audio and video bridging, public address functionality, other audio and/or video output functionality, etc. One example of an AVC system is included in the Q-SYS® technology from QSC, LLC, the assignee of the present disclosure.

In a generalized method of the present disclosure, an AVC operating system is implemented on an AVC processing core communicably coupled to one or more peripheral devices. The AVC processing core is configured to manage and control functionality of audio, video, and control features of the peripheral devices. The AVC processing core has many other capabilities that include, for example, playing an audio file, processing audio, video, or control signals and affecting the processing of any of these signals which may perform acoustic echo cancellation, and other processing that can affect the sound and camera quality of the peripherals.

Using an LLM module communicably coupled to the AVC processing core, the system detects one or more audio signals obtained from a user. The system then infers, using the LLM module, one or more oral commands from the audio signals. Thereafter, one or more actions corresponding to the oral commands are performed on the peripheral devices and/or the AVC processing core.

In yet another generalized embodiment, an AVC operating system is implemented on an AVC processing core communicably coupled to one or more peripheral devices. The AVC processing core is configured to manage and control functionality of audio, video, and control features of the peripheral devices. The AVC processing core has many other capabilities that include, for example, playing an audio file, processing audio, video, or control signals and affecting the processing of any of these signals which may perform acoustic echo cancellation, and other processing that can affect the sound and camera quality of the peripherals. The system obtains contextual awareness data of a room environment in which the AVC operating system functions. The contextual awareness data provides the system with situational awareness of the room environment and may take a variety of forms such as, for example, video, audio, textual or geo-spatial data, as well as data related to the status of one or more peripherals on the system. Thereafter, based upon the contextual awareness data, the system performs actions on the peripheral devices or AVC processing core.

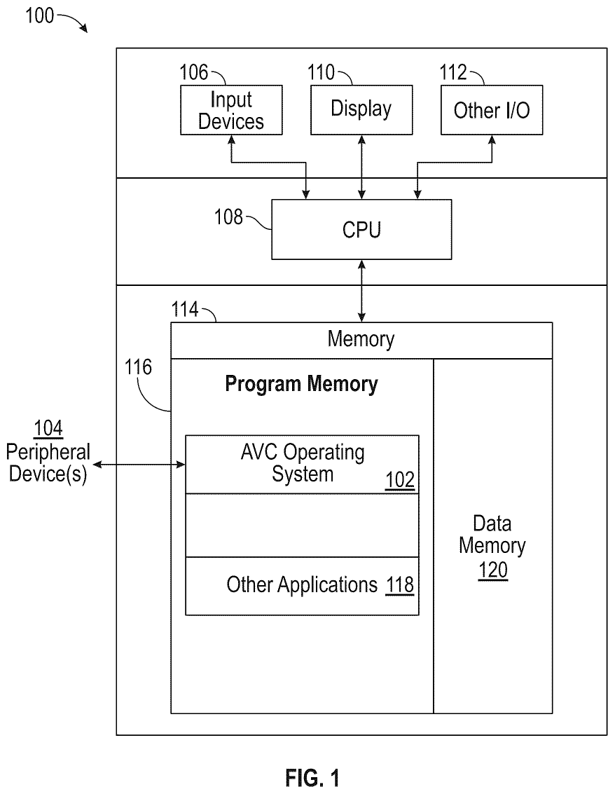

FIG. 1 is a block diagram illustrating an overview of an AVC processing core, according to certain illustrative embodiments of the present disclosure. AVC processing core 100 includes various hardware components, modules, etc., which comprise a AVC operating system (“OS”) 102 used to manage and control functionality of various audio, video and control features of one or more peripheral devices 104 or other applications/platforms (not shown) that may be running on peripheral devices 104 or one or more computing devices. Peripheral devices 104 may be any variety of devices such as, for example, cameras, microphones, bridging devices, network switches, speakers, televisions or other AV equipment, shades, heating or air conditioning units and so on. The applications/platforms may include, for example, calendar platforms, remote conferencing platforms, etc.

AVC processing core 100 can include one or more input devices 106 that provide input to the CPU(s) (processor) 108, notifying it of actions. The actions can be mediated by a hardware controller that interprets the signals received from the input device and communicates the information to the CPU 108 using a communication protocol. Input devices 106 include, for example, a mouse, a keyboard, a touchscreen, an infrared sensor, a touchpad, a wearable input device, a camera- or image-based input device, a microphone, personal computer, smart device, or other user input devices.

CPU 108 can be a single processing unit or multiple processing units in a device or distributed across multiple devices. CPU 108 can be coupled to other hardware devices, for example, with the use of a bus, such as a PCI bus or SCSI bus. The CPU 108 can communicate with a hardware controller for devices, such as for a display 110. Display 110 can be used to display text and graphics. In some implementations, display 110 provides graphical and textual visual feedback to a user. In some implementations, display 110 includes the input device as part of the display, such as when the input device is a touchscreen or is equipped with an eye direction monitoring system. In some implementations, the display is separate from the input device. Examples of display devices are an LCD display screen, an LED display screen, a projected, holographic, or augmented reality display (such as a heads-up display device or a head-mounted device), and so on. Other I/O devices 112 can also be coupled to the processor, such as a network card, video card, audio card, USB, firewire or other external device, camera, printer, speakers, CD-ROM drive, DVD drive, disk drive, or Blu-Ray device.

In some implementations, AVC processing core 100 also includes a communication device capable of communicating wirelessly or wire-based with a network node. The communication device can communicate with another device or a server through a network using, for example, TCP/IP protocols, a Q-LAN protocol, or others. AVC processing core 100 can utilize the communication device to distribute operations across multiple network devices.

The CPU 108 can have access to a memory 114 which may include one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 114 can include program memory 116 that stores programs and software, such as an AVC operating system 102 and other application programs 118. Memory 114 can also include data memory 120 that can include data to be operated on by applications, configuration data, settings, options or preferences, etc., which can be provided to the program memory 116 or any element of the AVC processing core 100.

Some implementations can be operational with numerous other computing system environments or configurations. Examples of computing systems, environments, and/or configurations that may be suitable for use with the technology include, but are not limited to, personal computers, AV I/O systems, networked AV peripherals, video conference consoles, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

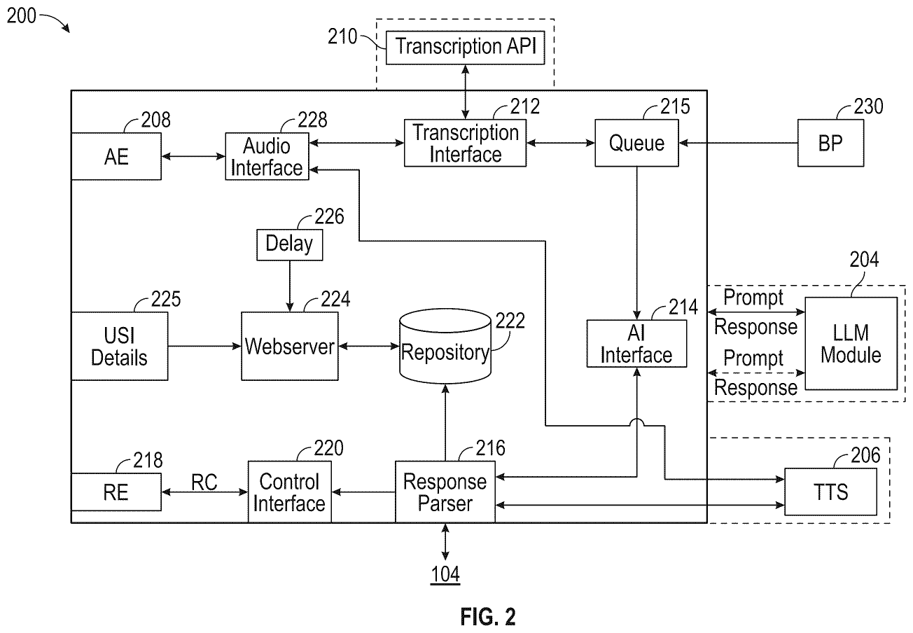

FIG. 2 is a block diagram of an AVC OS, according to certain illustrative embodiments of the present disclosure. In this example, the AVC OS 200 is AVC OS 102 of FIG. 1. In the example of FIG. 2, AVC OS 200 includes an LLM module 204 that executes a preconfigured command set to perform actions on peripheral devices 104, as will be discussed below. LLM module 204 may be any variety of large language models including, for example, ChatGPT, Google® Bard, Meta® LLaMA, etc. In alternative embodiments discussed later in this disclosure, the AVC OS includes an LLM module that is trained to interpret and automatically listen for oral commands. The various LLM modules described herein can be accessed as a cloud service, as a service within the local network “on-prem,” or hosted in the AVC processing core itself (thus denoted by the dotted lines in FIG. 2). Note the solid line around AVS OS 200 indicates modules which are part of AVC OS 200 in this example.

In further description of FIG. 2, AVC OS 200 includes a text-to-speech (“TTS”) module 206 which converts the text from the LLM module 204 to audio signals, sent into the AVC OS 200. The AVC OS 200 can then process these signals, for example, to mix into an output to a conference room. For example, peripheral speakers may be outputting audio data, e.g., from a remote conference (e.g., a laptop playing sound from a remote participant). AVC OS 200 can mix that audio data with the “speech” audio signals transmitted from the TTS module 206.

A digital signal processor 208, also referred to herein as the audio engine, accepts audio inputs to AVC OS 200 in any supported format or media from peripheral devices 104. Such formats or media may include, for example, network streams, VoIP, plain old telephone service (“POTS”), etc. or other formats or media. In this example, the audio signals are supplied as oral/audible commands issued from a user via a peripheral device 104 such as, for example, a microphone. Audio inputs may be processed by digital signal processor (“DSP”) 208 to perform typical input processing (filter, gate, automatic gain control (“AGC”), echo cancelling, etc.). In certain embodiments, audio signals may be processed to reduce the amount of data to be sent to a transcription service (labeled transcription application programming interface (“API”) module 210
which may or may not be part of the AVC OS 200 as indicated by the dotted lines). For example, to reduce the amount of data, the following audio processing techniques can be performed: level detection, voice activity detection, sample rate reduction, compression, and so on.

Audio signals are sent to API module 210, either with a local inter-process communication (IPC) mechanism or over the network as necessary. In certain embodiments, DSP 208 can provide local buffering (first in first out) to accommodate slow access to transcription API 210 or network interruptions. In other embodiments, the local buffering can be recorded to memory and preserved as a record of a meeting.

The output of transcription API module 210 is sent to LLM module 204 via a transcription interface 212 which performs software abstraction for communicating with the transcription API. For example, transcription interface 212 sends audio data to the transcription API 210 which then transcribes that audio data and sends it on to an artificial intelligence (“AI”) interface 214 which performs software abstraction for communicating with LLM module 204. For example, the interface 214 is responsible for placing the data in network packets or making the web call to the LLM module 204 to open it, or placing the data in a shared memory and sending it to the LLM module 204. Depending on the locations of the services, there may be a direct connection between transcription API 210 and LLM module 204 (for example in a cloud platform), or alternatively, the output of transcription API 210 returns to the AVC processing 100, and is then sent to LLM module 204. Nevertheless, once the transcription is received, LLM module 204 recognizes the speech intended to invoke a functionality (command detection) through the use of a variety of techniques such as, for example, system prompting, fine-tuning, and/or “function calling,” as will be understood by those ordinarily skilled in the art having the benefit of this disclosure. In each of these techniques, the LLM module 204 annotates its output with markup tags (e.g., such as with XML, markdown, JSON, and so on) that can be parsed by response parser 216, sent to runtime engine (“RE”) 218 (also referred to as the control engine which controls the peripherals, communication with the peripherals, and audio processing) via control interface 220 (software abstraction for the communication channel to/from RE 218 and dispatched to a functionality provider external to AVC OS 200. The markup tags may be in any language compatible and comprehensible by response parser 216.

Command sets related to control of the audio, video, or control system invoke control commands (aka, remote controls (“RC”)) which are then used to perform actions on peripheral devices 104 such as, for example, adjusting appropriate settings or other operations. For example, the volume may increase responsive to a user mentioning the volume is too low. Other settings include adjusting shades, turning on an air conditioner or changing the temperature of such, brightening a screen, summarizing a meeting, and other commands to peripheral devices 104 such as: turn the display on or off, change the video display input (whether coming from the laptop or from the internet), control the camera (put the camera in privacy mode or change pan-tilt-zoom coordinates), mute the audio (no audio going to the far end: where the audio is being transmitted to), turn the AI off, select different audio inputs, hang up a phone call, initiate a phone call, turn on transcription, reserve a conference room for a meeting at another time, generate a summary (send via email the summary to participants), update calendars of attendees, load a preset from a set of presets (put the room in ‘movie mode’ that a user has setup in advance-camera on, lights off, audio at certain volume), putting the blinds up or down, adjusting settings of an HVAC system, change configuration settings: change the time zone or set the clock, and so on.

One illustrative example of an RC/system prompt for controlling audio muting is a situation where an AVC system of the present disclosure is listening in on a conference room via a microphone peripheral device. The AVC system is capable of controlling aspects of the room by returning RCs as follows: When the AVC system detects, using the LLM module 204, the audio should be muted, LLM module 204 will respond with clearly specified text/command set such as: “<control command>system_mute-on</control_command>”. This can be parsed by the relatively “dumb” Response Parser 216 and forwarded to a control command handler. When the system detects, using LLM module 204, the audio should be unmuted, LLM module 204 can respond with a text/command set of: “<control command>system_mute-off</control_command>.”

In certain illustrative embodiments, an LLM is required to execute some commands. In these embodiments, the command handlers may use an LLM, such as LLM module 204 or another LLM (not shown), to assist in executing the commands such as, for example, summarizing a meeting; the summarization may be of ideas being audibly discussed in real-time. In the example of generating a summary, a command handler may send a transcript to an LLM with the instruction for the LLM to generate the summary.

In certain illustrative embodiments, the command handler may use an LLM to assist in executing commands when the LLM module (e.g., LLM module 204), that is used to detect commands, does not have computing resources available to allocate beyond that required for command detection or the LLM is not sufficiently sophisticated or “intelligent” to execute the command. For example, an LLM used for command detection may require more frequent, fewer compute-intensive tasks because the LLM may be called at the end of every spoken sentence during a meeting. However, to generate a quality summary of a meeting, or to execute an even more demanding command or task, an advanced LLM with the requisite computing resources and bandwidth may be required. The specific LLM module used to execute a command may vary depending on the power requirements to execute the given command, as will be understood by those ordinarily skilled in the art having the benefit of this disclosure.

In certain alternative embodiments, for certain command detection and summarizing needs, it may be infeasible to run an LLM module, that can execute each command or perform both command detection and execute the detected commands, on the AVC processing core. For example, although running an LLM locally (e.g., on the processing core) to execute all identified commands is contemplated within the scope of the present disclosure, given the current state of technology it may be very difficult to run a local LLM module to handle both command detection and summarization. In such cases, the LLM module can be run as a small, fine-tuned model locally that performs the simple command detection and, in parallel, a command handler tasked to execute certain commands, such as summarizing, transcription, and other commands, can pass the task to a cloud service for more “intelligent” processing. Another alternative is to use one or more cloud based LLM modules for command recognition and execution (e.g., summarization or other compute intensive tasks).

In other embodiments, the summaries can be communicated to the control system (via control interface 220) to show up in text fields on user control interfaces.

In other embodiments, the command sets can instruct LLM module 204 to ignore “small talk” and “chatter.” This may be accomplished by specifying the desired functionality of the LLM module 204 using, for example, a system prompt or fine tuning technique. In one example, ignoring small talk and chatter can be accomplished by providing the sentence “Please ignore small talk and chatter and return the string “<chatter/>” instead” to the system prompt. The exact prompt phrasing may need to be adjusted to maximize the effectiveness for the selected model.

In yet other embodiments, LLM module 204 can be instructed (by the command sets) to return markup tags to interact with other web services such as: appending comments to Confluence articles; appending comments or other modifications to Jira or Confluence items; interacting with calendaring and room scheduling, for example to extend the reservation for the current room when the meeting is running long; or to email summaries to the meeting participants.

In other embodiments, the LLM module 204 can listen for factual inaccuracies in the conversation and respond with a notification such as, for example, a red light on a touchscreen, text in a user control interface (UCI) text field, etc. In yet other embodiments, the LLM module 204 can cross check calendars to determine when attendees are available for another meeting, integrate with calendar scheduling platforms and perform web-booking, for example, to schedule a conference room and/or for discussion over a conferencing platform. In the embodiment here, the LLM module 204 does not provide any of these features, but it recognizes when this functionality is desired and dispatches a request, through a “calendaring functionality provider” to the scheduling platform.

In yet other illustrative embodiments, LLM module 204, using a peripheral microphone, can listen for direct requests (oral commands) and respond in chat-bot style. For example, LLM module 204 detects the following oral command: “Hey Big Q, what is the distance from the earth to the moon?” The result can be marked up so it can be sent to a speech synthesis service and the resulting audio sent back to DSP/AE 208 for playback in the room.

In yet other illustrative embodiments, direct requests are not necessary to initiate action by LLM module 204. The LLM module 204 can infer a question is being asked and that it should answer, for example, by detecting an inflection in tone or noting that a question has been asked and there is a time period for when attendees have not answered, and so on.

As previously discussed, in certain illustrative embodiments, LLM module 204 can identify a direct command from a user within the text, for example: “mute audio.” This direct command may begin with a wake word, for example, “Hey LLM, can you please mute the audio?” In yet another alternative embodiment, LLM module 204 analyzes the context of text to discern between a direct oral command and general conversation. For example, if a user enters a room and states, “it is cold in here,” the LLM module 204 can infer the user would like the temperature raised or the air conditioner turned down. As another example, a user may comment that there is a lot of glare on the whiteboard; LLM module 204 infers a command to close the blinds, then closes the blinds in the room. However, if a user makes a comment that temperature this summer is colder than normal, LLM module 204 may determine that is not a command for LLM module 204 to perform. Further, if there is a song playing in the background with lyrics, “it's getting hot in here” or “turn up the volume,” LLM module 204 may determine those are lyrics from songs and not a command for the program to perform. There are a variety of functionalities LLM module 204 can provide, as will be understood by those ordinarily skilled in the art having the benefit of this disclosure. Accordingly, oral commands may identified by the system directly through use of specific/direct commands.

Alternatively, the system may infer oral commands from general/peripheral conversations. Specific/direct commands may be, for example, “mute audio” (and system mutes audio), “I'd like to hear some background music” (and system turns on music), “skip to the next song please” (and systems skips to next song), or “Hey Big Q, what is the distance from the earth to the moon?” General/peripheral conversational language may be, for example, if a user enters the room and states “it's cold in here” (and the system activates the HVAC system to warm the room temperature), “its really dark in here” (and system turns lights on), “sorry, I can't hear you because the music is playing (and system turns off music), or “there is a glare on the whiteboard” (and system lowers the shades in the room). In such embodiments, LLM module 204 works in conjunction with transcription interface 212 and AI interface 214 to parse the text of the generalized conversational audio signal and match it with the closest direct command set(s) and thereby performing the corresponding system action.

A variety of matching techniques may be utilized by the system. In certain illustrative embodiments, LLM module 204 works in conjunction with AI interface 214, transcription interface 212 and response parser 216, among other components, to match the parsed generalized audio signal to a direct command. Here, in one example, AVC OS 200 may receive a variety of contextual information via direct user input (e.g., foundational room design, location of windows, white board, shades, etc.) in addition to other contextual data known about the location of the room environment (e.g., geographical location, weather, etc.)—all of which will be fed to LLM module 204. Armed with this data, LLM module 204 can then analyze the parsed generalized audio and compare it with the list of possible direct commands utilized by the control engine to control the peripherals 104. For example, if a user enters the room environment and mentions “there is a glare on the whiteboard,” AVC OS 200 receives and parses this signal, then feeds it to LLM module 204. There, LLM module 204 analyzes the parsed signal, contextual awareness data to determine there is direct sun light entering window X located on the east side of the building on a clear sunny day. The module 204 would then scan the list of available direct command sets to, for example, identify the command set corresponding to lowering of the shades on the east side of the building, and via the control engine direct that peripheral (shades) to lower accordingly.

Still referring to FIG. 2, AVC OS 200 may also include repository 222 which is a database to store responses. The response data can be provided through the webserver 224 to a web user interface (not shown) that provides an interface that shows the feed from the LLM module 204. User system interface (USI) details 225 are user-specific implementation details of the webserver 224 and web user interface. AVC OS 200 can also provide the responses to a debugger 226 for debugging any responses that are indicated as informal or otherwise improper (e.g., an output that does not match a specified format, or an unexpected categorization of “small talk or chatter”).

With further reference to FIG. 2, in certain embodiments, LLM module 204 can be prompted twice to remove vocal disfluencies. The first response may be used to “cleanup” the prompt, while the second response is used for command recognition. In such embodiments, the second prompt may be supplemented or based on the first response by LLM module 204.

In yet other embodiments, AVC OS 200 provides AVC processing core 100 the ability to configure itself based on who is attending the meeting. For example, settings (volume, brightness, and so on) of various peripheral devices 104 can be set according to meeting participants. Inside each system, presets can be provided which have a collection of settings that can configure a room for a particular use. For example, a conference room can be used for a meeting or a presentation. The AVC OS 200 can identify, according to logical rules, participants using voice detection of speaking room participants and match those voice signals to a table with known user voices. Alternatively, from a meeting invite, according to logical rules, AVC OS 200 can identify meeting participants, and if there are user profiles or histories associated with a participant, the system can have settings and configurations adjusted based on the user profile or history.

In yet other embodiments, AVC OS 200 provides the ability to implement various system configuration options, diagnostic options or debug options. For example, if there is a fault in the system (discovered by debugger 226), the response parser 216 will read the code to handle the faults, then redo the last items from the event log.

In other embodiments, AVC OS 200 can access the audio system via audio interface 228 to record the audio to a file. Here, the audio interface may receive audio data from a microphone or from a person on the other end of a laptop, and communicate that data to transcription interface 212. In such cases, there can be an oral command detect set (and a corresponding command set) to start or stop the recording. In yet other embodiments, the system can be audibly instructed to email the recording to desired persons/email addresses. Alternatively, audio interface 228 may receive audio data from TTS 206 that is then played out of speakers of the system.

In yet other embodiments, AVC OS 200 provides the ability for a user to issue oral commands to control a paging system that is part of the networked AVC system. Such oral commands can be to begin a page, voice the page, and then end the voiced page.

In other examples, AVC OS 200 also provides the ability to perform voice activity detection and is implemented in DSP/AE 208 so there is no blank audio; instead, there is only segments with voice. Here, AVC OS 200 determines if the sound coming from a microphone or other source contains a human voice speaking, as opposed to, for example, silence, keyboard typing, paper rustling, dog barking, car horn honking, music playing, and so on. Only voice signals need to be gathered and sent to the voice transcription service to save network bandwidth, processing time, and the cost of unnecessary transcription.

When any of the various subsystems of AVC OS 200 process data at different rates or on different size chunks of data, a system queue 215 may be necessary to hold data from the output of one system before it can be handled by the next. For example, a queue 215 may be needed so that a certain amount of LLM data can gather before sending to transcription API 210.

In yet other illustrative embodiments, the transcription data, via transcription API 210, can be received from a third party (“3P”) provider 230 such as Teams or Zoom platform. Such a platform would provide a 3^{rd} party transcription ingest, which refers to the feature where the AVC OS 200 can be used with some other system providing a voice transcription, which would be injected into this system at queue 215 and all subsequent steps of processing be applied, as described herein.

In yet another alternative embodiment of FIG. 2, each component of FIG. 2 (aside from the RE 218 and AE 208) could be running in the cloud or on another computer rather than on the processing core 100. These and other modifications will be apparent to those ordinarily skilled in the art having the benefit of this disclosure.

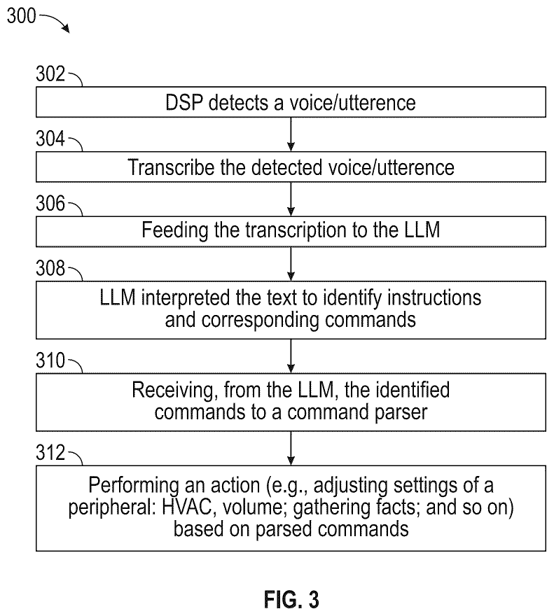

In view of the foregoing, FIG. 3 is a flow chart illustrating a generalized method to perform one or more actions on peripheral devices according to illustrative embodiments of the present disclosure. At block 302 of method 300, an AVC system as described herein detects an oral command issued from a user. At block 304, the AVC system transcribes the detected oral command/voice/utterance. At block 306, the AVC system communicates the transcribed data to the LLM module 204. At block 308, the LLM module interprets the text/transcribed data to identify instructions and corresponding command sets. At block 310, the AE/DSP 208 receives, from the LLM module 204, the identified command sets and sends them to the command parser 216. At block 312, the AVC system performs the action corresponding to the parsed command set. Such action may be, for example, adjusting settings of a peripheral like HVAC settings, volume of a speaker or display, brightness of a display or touch-screen controller, gathering facts from a data repository, blinds, etc.

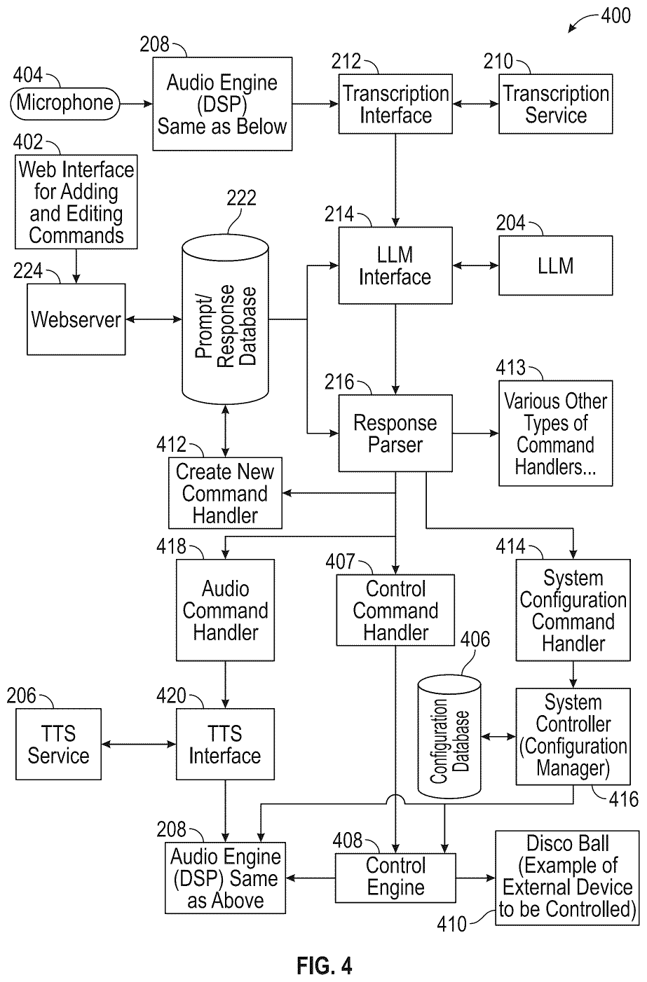

FIG. 4 is a block diagram of an AVC OS, according to certain illustrative embodiments of the present disclosure. In this example, the AVC OS 400 is AVC OS 102 of FIG. 1. AVC OS 200 employed an LLM module 204 which included a preconfigured command set to identify through use of a speech-to-text transcription. In the example of AVC OS 400, however, the AVC system may learn new commands, for example, from a user. AVC OS 400 includes some of the same components of AVC OS 200, with new components to enable the described learning functionality. AVC OS 400 can be taught or trained via a web interface 402 in a first embodiment, or in-person by a microphone 404 listening to a user providing audible instructions processed at the audio engine 208 in a second alternative embodiment.

In practice, a user would define something new (via the web interface or orally via the microphone) that he or she would like to control, along with the instruction for that prompt, to adjust the control and then feed that to the language model. The prompt instruction would be the specific code that, when executed, performs the command, e.g., control peripheral, process audio, video, or control signal a certain way (acoustic echo cancelation, gain adjustment, etc.), and so on. The LLM module 204 discerns the specific code from an interpretation of the transcription transcribed from transcription API 210. The LLM module 204 is “taught” what it is looking for and how to respond through a system prompt or fine tuning. In the earlier example of teaching the system to recognize mute, the instruction for the prompt would be, e.g., “when the user desires to mute the system, respond with . . . ”. So, the user teaches the LLM module 204 new controls and the corresponding command for adjusting the control of at least one of the peripheral devices or platforms/applications. In certain embodiments, system prompts are stored in the AI interface 214 and sent to the LLM module 204. A web user interface 402 is provided to allow the user to add and edit commands.

With reference to FIG. 4, an AVC OS 400 is illustrated according to certain illustrative embodiments of the present disclosure. Note that like numerals refer to components already described in relation to FIG. 2. AVC OS 400 is a block diagram illustrating an LLM module 204 learning to interpret new oral commands which are not default in the system. In a first illustrative embodiment, AVC OS 400 learns the new commands via a web interface for adding and editing commands, through the web server 224. A web page 402 contains a list of all named controls/command sets retrieved from a configuration database 406. Via web interface 402, a user selects a checkbox near a button icon, for example, and types the description “enable background music” then presses submit. This information is sent to the webserver 224 with a POST verb, and is inserted into the prompt/response database 222. The LLM interface (214) then builds the appropriate system prompt from these values using a template. For example, the prompt may be: “When the user wants to select background music, output the command <control_command>bgm_select-true</control_command>”. Note, if the system designer is sufficiently specific when naming controls, the LLM module 204 can determine the description from the name itself in certain embodiments.

Once AVC OS 400 has learned, via webserver 224, the various new prompts/responses are stored in prompt/response database 222. When LLM module 204 receives an oral command (e.g., “turn on disco ball” or “turn on light”), it is interpreted by response parser 216 using prompt database 222, and passed to control command handler 407. Control command handler 407 receives the parsed command and identifies it as a command necessary to implement some action by the control engine 408. Thereafter, control command handler 406 communicates the command to control engine 408 which instructs audio engine 208 to perform the corresponding operation such as, for example, open the blinds, to mute something, adjust volume or to control disco ball 410 (e.g., start spinning the ball, turn ball on/off, turn on ball lights, retract ball into ceiling, etc).

In an alternative embodiment, AVC OS 400 can learn via receiving oral instructions from a user on how to interpret new oral commands. The oral instructions may be received through a microphone 404 and processed at DSP 208. Here, for example, the user would say “Create new command to enable background music using bgm underscore select equals true”. The LLM module 204 recognizes this as an instruction to create a new command and responds with, for example, “<create_command><prompt>enable background music</prompt><response>bgm_select=true</response></create_command>”. This is dispatched by response parser 216 to create new command handler 412 that inserts the prompt and response into the database 222. Thus, in the future whenever LLM module 204 hears “turn down background music,” response parser 216 obtains the corresponding prompt/response from database 222 and communicates it to control engine 408 to perform the operation.

The various other command handlers 413 are for “connectors” to other systems. For example, to email the transcript of the meeting would require a command handler that sends an email by connecting to an email server. To create a Jira item (used for tracking tasks and bugs in a software development team) would require a command handler to connect to a Jira server. This would respond to a verbal command such as “Mark bug 23456 as resolved”. In another example, to check the weather would require a command handler that connects to a weather server. In this situation, the weather command handler, after receiving the result from the server, would send the weather data to the TTS Interface 420. In yet other embodiments, scheduling a meeting would require a command handler to connect to a calendaring server. There are a variety of other operations that could potentially be accomplished through this mechanism such as, for example, pushing messages to various types of chat channels (Slack, Yammer, Microsoft Teams, or Discord, etc.); sending commands to control other equipment through their unique APIs if they aren't controlled through the standard control command handler (Lights, thermostat, locks cameras, blinds and curtains, TV, etc.); creating or adding items to a to-do list; setting alarms and timers; or controlling streaming services (e.g. Netflix, Spotify, etc.).

In other illustrative embodiments, when AVC OS 400 receives oral commands to reconfigure the system, system configuration command handler 414 is used. For example, a reconfiguration may be for the system to change from a meeting room mode to a movie theatre room mode. Here, the response parser 216 will see these reconfiguration commands received via LLM module 204, and send those commands to handler 414. System controller 416 (aka, configuration manager) is then used to reconfigure the audio engine 208 and control engine 408. The new configurations may be stored in configuration database 406 and retrieved by system controller 416 once identified via LLM module 204.

The audio command handler 418 is for commands where the user made a request or asked a question that LLM module 204 identified and generated a response intended to be played audibly in the room. For example, asking a question of fact such as “how tall is mount Everest” would invoke the audio command handler 418 with the data “Mount Everest, the highest mountain in the world, is approximately 29,032 feet (8,849 meters) tall above sea level”. This information would be converted to audio via the TTS interface 420 and the audio would be sent to the audio engine 208 where it can be mixed and sent to the speakers.

In yet other embodiments, in addition to adding or appending information from a conference to Jira or Confluence, AVC OS 400 may retrieve relevant information from Jira, Confluence, and so on to provide context for a conversation. In such an embodiment, command handler 413 would perform these operations. Command handler 413 would push the material (images, text from the page or text from the meeting transcribed by the speech-to-text, and so on) from Jira or Confluence to a display or to the web interface 402 via web server 224 (e.g., by using a web socket). There are a variety of ways in which this could be accomplished including, for example, a retrieval augmented generation (“RAG”) program such as IBM's Watsonx.

In other embodiments, response parser 216 communicates with a feature toggle handler which handles changes between the various command handlers. The feature toggle handler toggles those handle features on/off. In addition to the command handlers described herein, others handlers 413 may include a jargon handler which assists LLM module 204 with recognizing when a user speaks in jargon. Other command handlers 413 can include a knowledge handler which assists LLM module 204 with interpreting and retrieving answers to questions such as “what is the meaning of PTO?” or other knowledge-based questions. Another handler 413 could be a summary handler which assists LLM module 204 in responding to summary questions such as “what happened on this date in 2015?”—to provide a summary of those events.

In yet other illustrative embodiments, in situations where multiple AVC processing cores 100 are networked with one another (e.g., on the cloud), when one AVC processing core is taught a command, the taught command can be communicated to the other secondary AVC processing cores on the network. Thus, all the cores can learn from the one taught core or, likewise, from many other taught processing cores.

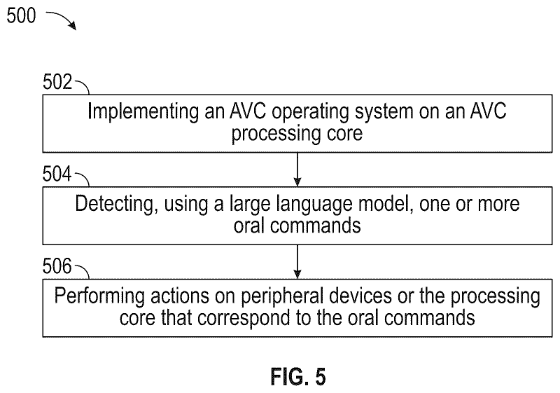

FIG. 5 is a flow chart of a computer-implemented method 500 of the present disclosure. At block 502, an AVC operating system is implemented on an AVC processing core. The processing core is communicably coupled to one or more peripheral devices. As described herein, the AVC processing core is configured to manage and control functionality of audio, video and control features of the peripheral devices. At block 504, one or more oral commands of a user are detected using an LLM module communicably coupled to the AVC processing core. At block 506, the AVC system performs actions on the peripheral devices or AVC processing core that correspond to the oral commands.

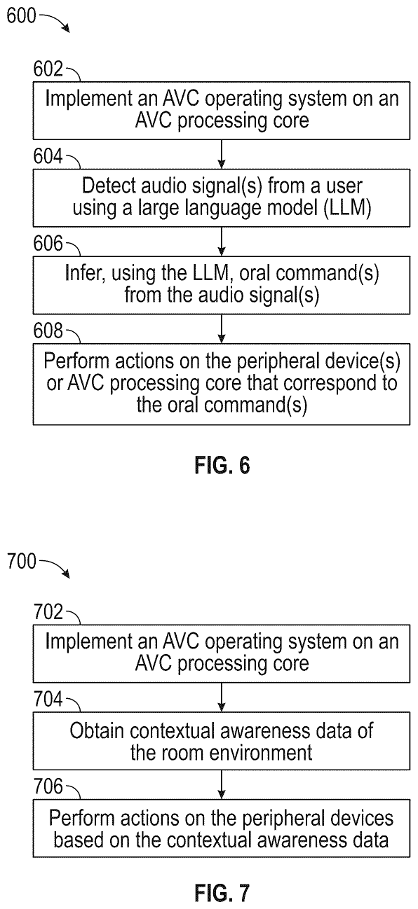

FIG. 6 is a flow chart of a method of inferring oral commands using audio signals from generalized conversations, according to certain illustrative embodiments of the present disclosure. In method 600, at block 602, the system implements an AVC operating system on an AVC processing core. At block 604, the AVC system detects one or more audio signals of a user via the LLM. At block 606, the system infers one or more oral commands from the audio signals using the LLM. In one example, using the LLM, the AVC system compares the parsed text of the audio signals to the oral command sets to determine which command most closely matches the parsed text. The closets matching command in the set is them implemented by the system. Thereafter, at block 608, the system performs actions on the peripheral devices or AVC processing core which correspond to the oral command(s).

In yet other illustrative embodiments, the AVC systems described herein uses contextual information of the room environment to control the peripheral devices. Such contextual information may include, for example, the geographic location of the room space, the open/closed status of blinds, or the direction in which the windows face. Using reasoning of the LLM, the AVC system performs actions on the peripherals based on a more complete spatial awareness of the room environment and it's present state of controls that have been fed to the system through one or more prompts registered to the AVC system.

In one example, a user can add in a variety of peripherals (build a room model) using a room design interface which allows registering of those capabilities to the foundational model. Examples of peripherals include one or more shades in the room, lighting, climate control system(s), tables, chairs, along with their location within the room environment. The user can also input text in the room design to provide further context on the peripherals. For example, the location of the shades can be input, along with text there is a display five meters away. This data can be fed into an LLM (e.g., LLM module 204) as a system prompt for control. During operation, the LLM module may calculate the angle of the sun at given times of day and latitude/longitude location of room, in order to determine if the shades need to be adjusted and/or the HVAC system needs to be adjusted. Here, contextual awareness data also includes the status of various peripherals such as the HVAC (e.g., activated/deactivated?, current set temperature, etc) or the shades (e.g., 20% open, 50% open, closed, etc). The AVC system may continually update peripheral settings/statuses based on this contextual information.

In another example, the AVC system itself generates prompts based on audio and/or video signals. During operation, the LLM (e.g., LLM module 204) has access to the settings/configurations of the peripherals 104, in addition to any other contextual information input by the user. Based upon this information, the system itself can determine and build prompts for peripheral control to optimize the system accordingly. For example, based on analysis of video signals, the system can determine there is a glare on the white board. In response, the system generates one or more prompts to affect lowering of shades in the room environment. Further, since the system also knows other contextual information (e.g., time of day, position of sun, etc), the system can determine which shades need to be lowered and which ones can remain open.

In other embodiments, the audio level of the room environment can also be fed to the LLM as contextual awareness data. If the audio level is too low, the AVC system could adjust the dba higher or vice versa. If the room environment has been quiet for a certain time period (e.g., 20 minutes), the system could automatically shut down or go into a sleep mode.

In addition to geo-spatial data of the room, the contextual awareness data may also be weather related. In such examples, the weather in the local area may be used to give the AVC system context into the room environment (e.g., to provide weather related updates/alarms, adjust HVAC systems based on weather, increase audio based on noise generated by high winds or rain, etc).

Accordingly, such AVC systems may utilize a continuous and closed loop between the AVC system, contextual awareness data and peripherals. The contextual awareness data could be entered into the system during the room design setup phase or otherwise (as textual data)—via a suitable user interface. The contextual awareness data could also be video data obtained from one or more peripheral devices (e.g., video monitor). In this example, a video monitor observes a glare on the whiteboard which is detected by the AVC system through analysis of the video signals. In turn, a corresponding textual control prompt is sent to the LLM module to lower the shades at the relevant locations inside the room environment (the relevant shades to be lowered can be determined based upon the geo-spatial location of the room relative to the location of the sun, etc.).

Alternatively, in this same example, a user could state “its hard to see the screen today,” and, based upon this received audio signal, the AVC system determines (using contextual awareness data—the sun's location, open/closed status of shades, etc) the shades need to be lowered (or lowered more if they are only partially lowered).

In yet another example, the contextual awareness data fed to the AVC system reflects five chairs around the conference room table (e.g., video signals obtained from a room monitor only shows five chairs). However, the AVC system is also fed room reservation data listing seven persons attending the meeting. As such, before the meeting, the AVC system is prompted (based upon this contextual awareness data) to send a message or place a call to building staff to deliver two additional chairs.

Accordingly, the AVC system uses reasoning logic to determine which actions to perform on peripherals based on the context of the room and/or the peripheral controls it has available.

FIG. 7 is a flow chart of a method to perform actions on peripheral device(s) using contextual awareness data, according to certain illustrative embodiments of the present disclosure. In method 700, at block 702, an AVC operating system is implemented on an AVC processing core. At block 704, contextual awareness data of the room environment is obtained by the system. At block 706, the system then performs actions on one or more peripheral devices using the contextual awareness data.

Methods and embodiments described herein further relate to any one or more of the following paragraphs:
1. A computer-implemented method, comprising: implementing an audio, video and control (“AVC”) operating system on an AVC processing core communicably coupled to one or more peripheral devices, the AVC processing core being configured to manage and control functionality of the peripheral devices, wherein the AVC operating system is adapted to perform actions using oral commands detected within audio signals, the oral commands corresponding to the actions; detecting, using a large language model (“LLM”) module communicably coupled to the AVC processing core, one or more audio signals obtained from a user; inferring, using the LLM module, one or more oral commands from the audio signals; and performing actions on the peripheral devices or AVC processing core which correspond to the oral commands.
2. The computer-implemented claim as defined in paragraph 1, wherein inferring the oral commands comprises: analyzing, using the LLM, the audio signals to determine which oral commands the audio signals most closely match; and performing actions on the peripheral devices or AVC processing core which correspond to the matched oral commands.
3. The computer-implemented method as defined in paragraph 1 or 2, wherein the LLM module executes a preconfigured command set to perform actions on the peripheral devices.
4. The computer-implemented method as defined in any of paragraphs 1-3, wherein the LLM module executes a taught command set to perform actions on the peripheral devices, the taught command set being taught by the user.
5. The computer-implemented method as defined in any of paragraphs 1-4, wherein the taught command set is obtained from the user via a web interface.
6. The computer-implemented method as defined in any of paragraphs 1-5, wherein the taught command set is obtained from the user via a listening device.
7. The computer-implemented method as defined in any of paragraphs 1-6, wherein the AVC processing core communicates the taught command set to one or more secondary AVC processing cores, thereby teaching the secondary AVC processing cores the taught command set.
8. The computer-implemented method as defined in any of paragraphs 1-7, wherein the LLM module is accessed from a cloud service, local network service, or on the AVC processing core.
9. A system, comprising: one or more peripheral devices; and an audio, video and control (“AVC”) processing core communicably coupled to the peripheral devices, the AVC processing core having an AVC operating system executable thereon to manage and control functionality of the peripheral devices, wherein the AVC operating system is adapted to perform actions using oral commands detected within audio signals, the oral commands corresponding to the actions, wherein the AVC operating system is configured to perform operations comprising: detecting, using a large language model (“LLM”) module communicably coupled to the AVC processing core, one or more audio signals obtained from a user; inferring, using the LLM module, one or more oral commands from the audio signals; and performing actions on the peripheral devices or AVC processing core which correspond to the oral commands.
10. The system as defined in paragraph 9, wherein inferring the oral commands comprises analyzing, using the LLM, the audio signals to determine which oral commands the audio signals most closely match; and performing actions on the peripheral devices or AVC processing core which correspond to the matched oral commands.
11. The system as defined in paragraph 9 or 10, wherein the LLM module executes a preconfigured command set to perform actions on the peripheral devices.
12. The system as defined in any of paragraphs 9-11, wherein the LLM module executes a taught command set to perform actions on the peripheral devices, the taught command set being taught by the user.
13. The system as defined in any of paragraphs 9-12, wherein the taught command set is obtained from the user via a web interface.
14. The system as defined in any of paragraphs 9-13, wherein the taught command set is obtained from the user via a listening device.
15. The system as defined in any of paragraphs 9-14, wherein the AVC processing core communicates the taught command set to one or more secondary AVC processing cores, thereby teaching the secondary AVC processing cores the taught command set.
16. The system as defined in any of paragraphs 9-15, wherein the LLM module is accessed from a cloud service, local network service, or on the AVC processing core.
17. A computer-implemented method, comprising: implementing an audio, video and control (“AVC”) operating system on an AVC processing core communicably coupled to one or more peripheral devices, the AVC processing core being configured to manage and control functionality of the peripheral devices, obtaining contextual awareness data of a room environment in which the AVC operating system functions; and based upon the contextual awareness data, performing actions on the peripheral devices or AVC processing core.
18. The computer-implemented method as defined in paragraph 17, wherein the contextual awareness data is video data.
19. The computer-implemented method as defined in paragraph 17 or 18, wherein the contextual awareness data is audio data.
20. The computer-implemented method as defined in any of paragraphs 17-19, wherein the contextual awareness data is textual data.
21. The computer-implemented method as defined in any of paragraphs 17-20, wherein the textual data is obtained from the user via a user interface.
22. The computer-implemented method as defined in any of paragraphs 17-21, wherein the contextual awareness data is status data of the peripheral devices.
23. The computer-implemented method as defined in any of paragraphs 17-22, wherein the contextual awareness data is geo-spatial data of the room environment.
24. A system, comprising: one or more peripheral devices; and an audio, video and control (“AVC”) processing core communicably coupled to the peripheral devices, the AVC processing core having an AVC operating system executable thereon to manage and control functionality of the peripheral devices, wherein the AVC operating system is adapted to perform operations comprising: obtaining contextual awareness data of a room environment in which the AVC operating system functions; and based upon the contextual awareness data, performing actions on the peripheral devices or AVC processing core.
25. The system as defined in paragraph 24, wherein the contextual awareness data is video data.
26. The system as defined in paragraph 24 or 25, wherein the contextual awareness data is audio data.
27. The system as defined in any of paragraphs 24-26, wherein the contextual awareness data is textual data.
28. The system as defined in any of paragraphs 24-27, wherein the textual data is obtained from the user via a user interface.
29. The system as defined in any of paragraphs 24-28, wherein the contextual awareness data is status data of the peripheral devices.
30. The system as defined in any of paragraphs 24-29, wherein the contextual awareness data is geo-spatial data of the room environment.

Moreover, the methods described herein may be embodied within a system comprising processing circuitry to implement any of the methods, or a in a non-transitory computer-readable medium comprising instructions which, when executed by at least one processor, causes the processor to perform any of the methods described herein.

Although various embodiments and methods have been shown and described, the disclosure is not limited to such embodiments and methods and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

What is claimed is:

1. A computer-implemented method, comprising:
implementing an audio, video and control (“AVC”) operating system on an AVC processing core communicably coupled to one or more peripheral devices, the AVC processing core being configured to manage and control functionality of the peripheral devices,
wherein the AVC operating system is adapted to perform actions using oral commands detected within audio signals, the oral commands corresponding to the actions;
detecting, using a large language model (“LLM”) module communicably coupled to the AVC processing core, one or more audio signals obtained from a user;
inferring, using the LLM module, one or more oral commands from the audio signals; and
performing actions on the peripheral devices or AVC processing core which correspond to the oral commands.

2. The computer-implemented claim as defined in claim 1, wherein inferring the oral commands comprises:
analyzing, using the LLM, the audio signals to determine which oral commands the audio signals most closely match; and
performing actions on the peripheral devices or AVC processing core which correspond to the matched oral commands.

3. The computer-implemented method as defined in claim 1, wherein the LLM module executes a preconfigured command set to perform actions on the peripheral devices.

4. The computer-implemented method as defined in claim 1, wherein the LLM module executes a taught command set to perform actions on the peripheral devices, the taught command set being taught by the user.

5. The computer-implemented method as defined in claim 4, wherein the taught command set is obtained from the user via a web interface.

6. The computer-implemented method as defined in claim 4, wherein the taught command set is obtained from the user via a listening device.

7. The computer-implemented method as defined in claim 4, wherein the AVC processing core communicates the taught command set to one or more secondary AVC processing cores, thereby teaching the secondary AVC processing cores the taught command set.

8. The computer-implemented method as defined in claim 1, wherein the LLM module is accessed from a cloud service, local network service, or on the AVC processing core.

9. A system, comprising:
one or more peripheral devices; and
an audio, video and control (“AVC”) processing core communicably coupled to the peripheral devices, the AVC processing core having an AVC operating system executable thereon to manage and control functionality of the peripheral devices,
wherein the AVC operating system is adapted to perform actions using oral commands detected within audio signals, the oral commands corresponding to the actions,
wherein the AVC operating system is configured to perform operations comprising:
detecting, using a large language model (“LLM”) module communicably coupled to the AVC processing core, one or more audio signals obtained from a user;
inferring, using the LLM module, one or more oral commands from the audio signals; and
performing actions on the peripheral devices or AVC processing core which correspond to the oral commands.

10. The system as defined in claim 9, wherein inferring the oral commands comprises:
analyzing, using the LLM, the audio signals to determine which oral commands the audio signals most closely match; and
performing actions on the peripheral devices or AVC processing core which correspond to the matched oral commands.

11. The system as defined in claim 9, wherein the LLM module executes a preconfigured command set to perform actions on the peripheral devices.

12. The system as defined in claim 9, wherein the LLM module executes a taught command set to perform actions on the peripheral devices, the taught command set being taught by the user.

13. The system as defined in claim 12, wherein the taught command set is obtained from the user via a web interface.

14. The system as defined in claim 12, wherein the taught command set is obtained from the user via a listening device.

15. The system as defined in claim 12, wherein the AVC processing core communicates the taught command set to one or more secondary AVC processing cores, thereby teaching the secondary AVC processing cores the taught command set.

16. The system as defined in claim 9, wherein the LLM module is accessed from a cloud service, local network service, or on the AVC processing core.

17. A non-transitory computer-readable storage medium storing instructions that, when executed by a computing system, cause the computing system to perform operations comprising:
implementing an audio, video and control (“AVC”) operating system on an AVC processing core communicably coupled to one or more peripheral devices, the AVC processing core being configured to manage and control functionality of the peripheral devices,
wherein the AVC operating system is adapted to perform actions using oral commands detected within audio signals, the oral commands corresponding to the actions,
wherein the AVC operating system is configured to perform operations comprising:
detecting, using a large language model (“LLM”) module communicably coupled to the AVC processing core, one or more audio signals obtained from a user;
inferring, using the LLM module, one or more oral commands from the audio signals; and
performing actions on the peripheral devices or AVC processing core which correspond to the oral commands.

18. The computer-readable storage medium as defined in claim 17, wherein inferring the oral commands comprises:
analyzing, using the LLM, the audio signals to determine which oral commands the audio signals most closely match; and
performing actions on the peripheral devices or AVC processing core which correspond to the matched oral commands.

19. The computer-readable storage medium as defined in claim 17, wherein the LLM module executes a preconfigured command set to perform actions on the peripheral devices.

20. The computer-readable storage medium as defined in claim 17, wherein the LLM module executes a taught command set to perform actions on the peripheral devices, the taught command set being taught by the user.

21. The computer-readable storage medium as defined in claim 20, wherein the taught command set is obtained from the user via a web interface.

22. The computer-readable storage medium as defined in claim 20, wherein the taught command set is obtained from the user via a listening device.

23. The computer-readable storage medium as defined in claim 20, wherein the AVC processing core communicates the taught command set to one or more secondary AVC processing cores, thereby teaching the secondary AVC processing cores the taught command set.

24. The computer-readable storage medium as defined in claim 20, wherein the LLM module is accessed from a cloud service, local network service, or on the AVC processing core.

25. A computer-implemented method, comprising:
implementing an audio, video and control (“AVC”) operating system on an AVC processing core communicably coupled to one or more peripheral devices, the AVC processing core being configured to manage and control functionality of the peripheral devices,
obtaining contextual awareness data of a room environment in which the AVC operating system functions; and
based upon the contextual awareness data, performing actions on the peripheral devices or AVC processing core.

26. The computer-implemented method as defined in claim 25, wherein the contextual awareness data is video data.

27. The computer-implemented method as defined in claim 25, wherein the contextual awareness data is audio data.

28. The computer-implemented method as defined in claim 25, wherein the contextual awareness data is textual data.

29. The computer-implemented method as defined in claim 28, wherein the textual data is obtained from the user via a user interface.

30. The computer-implemented method as defined in claim 25, wherein the contextual awareness data is status data of the peripheral devices.

31. The computer-implemented method as defined in claim 25, wherein the contextual awareness data is geo-spatial data of the room environment.

32. A system, comprising:
one or more peripheral devices; and
an audio, video and control (“AVC”) processing core communicably coupled to the peripheral devices, the AVC processing core having an AVC operating system executable thereon to manage and control functionality of the peripheral devices,
wherein the AVC operating system is adapted to perform operations comprising:
obtaining contextual awareness data of a room environment in which the AVC operating system functions; and
based upon the contextual awareness data, performing actions on the peripheral devices or AVC processing core.

33. The system as defined in claim 32, wherein the contextual awareness data is video data.

34. The system as defined in claim 32, wherein the contextual awareness data is audio data.

35. The system as defined in claim 32, wherein the contextual awareness data is textual data.

36. The system as defined in claim 35, wherein the textual data is obtained from the user via a user interface.

37. The system as defined in claim 32, wherein the contextual awareness data is status data of the peripheral devices.

38. The system as defined in claim 32, wherein the contextual awareness data is geo-spatial data of the room environment.

39. A non-transitory computer-readable storage medium storing instructions that, when executed by a computing system, cause the computing system to perform operations comprising:
implementing an audio, video and control (“AVC”) operating system on an AVC processing core communicably coupled to one or more peripheral devices, the AVC processing core being configured to manage and control functionality of the peripheral devices,
obtaining contextual awareness data of a room environment in which the AVC operating system functions; and
based upon the contextual awareness data, performing actions on the peripheral devices or AVC processing core.

40. The computer-readable storage medium as defined in claim 39, wherein the contextual awareness data is video data.

41. The computer-readable storage medium as defined in claim 39, wherein the contextual awareness data is audio data.

42. The computer-readable storage medium as defined in claim 39, wherein the contextual awareness data is textual data.

43. The computer-readable storage medium as defined in claim 42, wherein the textual data is obtained from the user via a user interface.

44. The computer-readable storage medium as defined in claim 39, wherein the contextual awareness data is status data of the peripheral devices.

45. The computer-readable storage medium as defined in claim 39, wherein the contextual awareness data is geo-spatial data of the room environment.
